(19) United States
(12) Patent Application Publication
(10) Pub. No.: US 2006/0228642 A1
(43) Pub. Date: Oct. 12, 2006

(54) Method for preparing polymer latex particles having core/shell structure

(75) Inventors: Jun-young Lee, Seoul (KR); Sang-woo Kim, Seongdong-gu (KR); Kyung-yol Yon, Seongnam-si (KR); Chang-kook Hong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/300,426

(22) Filed: Dec. 15, 2005

(30) Foreign Application Priority Data
Apr. 7, 2005 (KR) 10-2005-0029082

(51) Int. Cl. G03G 5/00; C08F 2/44

(52) U.S. Cl. 430/137.15; 430/137.1; 524/763; 524/700

(57) ABSTRACT

A method for preparing polymer latex particles having a core/shell structure includes the steps of: forming a dispersion of colorant; heating and mixing an organic phase comprising core monomers and wax to form a blend of the wax and monomers; mixing the dispersion of colorant with the blend of wax and monomers, and adding a first polymerization initiator for forming the core to the resultant mixture to perform polymerization, thereby forming core polymer particles comprising the wax and colorant; and mixing shell-forming monomers with the polymer particles comprising the wax and colorant, and adding a second polymerization initiator for forming the shell to the resultant mixture to perform polymerization, thereby forming a shell layer on the core polymer particles, wherein the colorant is a pigment, and the polymerization initiator for forming the core includes an azo-based polymerization initiator. The method is cost-efficient because the core/shell polymer latex particles are prepared by a simple emulsion polymerization process, with no need of additional cohesion or melting processes. Additionally, when the core/shell polymer latex is used in a polymer composition, it is possible to improve a bonding degree between heterogeneous particles of a colorant, wax and latex and distribution uniformity of the particles, and thus to control the content of each component with ease.

### CROSS-REFERENCE TO RELATED APPLICATIONS

This application claims benefit under 35 U.S.C. § 119 from Korean Patent Application No. 2005-29082, filed on Apr. 7, 2005, the entire content of which is hereby incorporated by reference.

### BACKGROUND OF THE INVENTION

1. Field of the Invention

The present invention relates to a method for preparing polymer latex particles. More particularly, the present invention relates to a method for preparing polymer latex particles that have a core/shell structure, wherein the core comprises a colorant and a wax, and exhibit desired physical properties due to the smooth progress of the polymerization reaction that produces the polymer latex particles.

2. Description of the Related Art

In general, a polymer composition includes a polymer resin. Methods for preparing a polymer resin include emulsion polymerization, suspension polymerization, dispersion polymerization, etc. Among those, emulsion polymerization is widely used when it is necessary to control the particle size of a polymer particle. Emulsion polymerization has an advantage of controlling the particle size of a resultant polymer particle.

Emulsion polymerization is referred to as polymerization process wherein micelles are spontaneously formed in an aqueous phase containing monomers or polymers, a surfactant, initiator, etc., when the surfactant is present in an amount exceeding a predetermined concentration. Typically, emulsion polymerization includes a process wherein an initiator forms radicals in an aqueous phase and the radicals are bonded with monomers within the micelles.

A so-called latex refers to a dispersion of fine natural or synthetic polymer particles in a solvent, wherein the polymer particles have a size of about 1 μm or less and are formed in a binary system. In order to form a polymer latex, it is necessary to mix and react monomers, a surfactant, initiator, etc., followed by emulsion polymerization.

A latex resin may be formed to have a core/shell structure depending on the polymer composition used therein. In the case of such a core/shell latex, a latex resin comprising a core containing other components used in the polymer composition has an advantage in that the content of each component can be controlled with ease.

Particularly, when a latex resin is used in a toner composition for image forming devices, other additives used in the toner composition can be included in the core of the latex resin.

A toner composition for image forming devices is used as developer and comprises, in general, a colorant, binder resin, antistatic agent and other functional additives.

Colorants may be classified broadly into dye-based colorants and pigment-based colorants. Among those, pigment-based colorants are more widely used as the colorant for toners, because they have excellent thermal stability and photoresistance compared to dye-based colorants.

Binder resins are used in a toner in an amount of about 90% based on the total weight of the toner and serve to fix toner particles onto a recording medium. There are many kinds of polymer materials that may be used as binder resins. Particularly, latex resins are used preferably.

Antistatic agents are used in order to control the quantity of electric charge, charged to toner particles, and particular examples thereof include metal azo compounds, salicylic acid-metal complexes, nigrosin, quaternary ammonium salts, etc.

Among the additives, a release agent is added to a toner in order to improve the release property. Such release agents are added to a toner composition to improve the release property between a roller and toner when a toner image is transferred and fixed to a recording medium, and to prevent a toner offset phenomenon. The release agents also prevent the recording medium from jamming in a roller due to the adhesion of the recording medium to the roller caused by the toner.

Release agents that may be used include low-molecular weight polyolefins, silicones having a softening point upon heating, fatty acid amides, wax, etc. Generally, wax is used as release agent.

Meanwhile, it is possible to prepare latex particles having core containing wax as a release agent or a colorant and to provide a toner composition by using the same latex resin.

As disclosed in the prior art, such as, U.S. Pat. Nos. 6,120,967 and 5,863,696, when emulsion particles of a latex, pigment and wax are bonded to each other, bonding among homogeneous particles occurs in addition to bonding among heterogeneous particles, resulting in degradation in the bonding effect among heterogeneous particles. Additionally, according to the prior art, a cohesive agent used for preparing latex particles adversely affects the physical particles of the resulting toner.

However, when a colorant or wax is included in the core of latex particles, it is possible to improve the bonding effect among heterogeneous particles and to avoid the above-mentioned problem caused by the use of a cohesive agent.

However, in a conventional process for preparing a latex core comprising a colorant as well as monomers, there is a problem in that it is difficult to prepare a core/shell latex, because the colorant serves as a scavenger that inhibits the polymerization of monomers.

### SUMMARY OF THE INVENTION

Therefore, the present invention has been made in view of the above-mentioned problems. An object of the present invention is to provide a method for preparing core/shell type polymer latex particles capable of improving a bonding degree among heterogeneous particles, characterized in that the core comprises a colorant that is produced by different kinds of polymerization initiators.

To accomplish the above object, a method is provided for preparing polymer latex particles having a core/shell structure. The method comprises the steps of: forming a dispersion of a colorant; heating and mixing an organic phase comprising core-forming monomers and a wax to form a blend of the wax and monomers; mixing the dispersion of the colorant with the blend of the wax and monomers, and adding a first polymerization initiator for forming the core to the resultant mixture to polymerize the monomer, thereby forming core polymer particles comprising the wax and colorant. Thereafter, shell-forming monomers are mixed with the polymer particles comprising the wax and the colorant, and a second polymerization initiator is added to the mixture for forming the shell to polymerize the shell-forming monomers, thereby forming a shell layer on the core polymer particles, wherein the colorant is a pigment, and the polymerization initiator for forming the core includes an azo-based polymerization initiator.

More particularly, the azo-based polymerization initiator is selected from the group consisting of an azoamidine compound, azoamide compound, azoalkyl compound, azoester compound and an azonitrile compound.

The polymerization initiator for forming the core is selected from the group consisting of a mixed initiator of an azo-based polymerization initiator with a persulfate-based polymerization initiator and a mixed initiator of an azo-based polymerization initiator with a peroxide-based polymerization initiator.

Preferably, the mixing ratio of the azo-based polymerization initiator with the persulfate-based polymerization initiator is 1:1.

Preferably, the mixing ratio of the azo-based polymerization initiator with the peroxide-based polymerization initiator is 1:1.

In the step of forming the core polymer particles, polymerization is preferably performed at a temperature of about 50° C. to 80° C. for about 2-10 hours.

Preferably, the core polymer particles have a particles size of between about 100 nm and 500 nm.

In the step for forming the shell layer, polymerization is preferably performed at a temperature of about 50° C. to 80° C. for about 5-20 hours.

The core monomer includes a monomer selected from the group consisting of a styrenic monomer, acrylate monomer, methacrylate monomer, acrylic acid, itaconic acid, methacrylic acid, maleic acid, fumaric acid, vinyl monomer, acrylonitrile, butadiene and isoprene.

The shell monomer includes a monomer selected from the group consisting of a styrenic monomer, acrylate monomer, methacrylate monomer, acrylic acid, itaconic acid, methacrylic acid, maleic acid, fumaric acid, vinyl monomer, acrylonitrile, butadiene and isoprene.

The dispersion of colorant is prepared by mixing and dispersing a colorant, dispersant and deionized water.

The colorant includes at least one selected from the group consisting of azo-based pigments, phthalocyanine-based pigments, basic dye-based pigments, quinacridone-based pigments, dioxazine-based pigments, condensed azo-based pigments, carbon black, chromates, ferrocyanides, oxides, sulfides, selenides, sulfates, silicates, carbonates, phosphates and metal powder.

The wax includes at lease one selected from the group consisting of carnauba wax, bayberry wax, bees wax, Shellac wax, Spermacetti wax, Montan wax, Ozokerite wax, Ceresine wax, paraffin wax, microcrystalline wax, Fischer-Tropsch wax, polyethylene wax, polypropylene wax, acrylate wax, fatty acid amide wax, silicone wax and polytetrafluoroethylene wax.

Preferably, the core/shell polymer latex particles have a glass transition temperature (Tg) of between 40° C. and 100° C. and a melting point of between 50° C. and 150° C.

Preferably, the core/shell polymer latex particles have a particle size of between 0.1 μm and 3 μm.

### DETAILED DESCRIPTION OF THE PREFERRED EMBODIMENTS

Hereinafter, the present invention will be explained in more detail.

A polymer latex can be used as a binder in a polymer composition, particularly in a toner composition for image forming devices. The core/shell polymer latex according to the present invention includes a core containing a colorant and wax, and thus can be used in a toner composition as the binder and also as release agent and colorant for the toner composition.

First, a dispersion of colorant is formed in order to prepare the core/shell latex according to the present invention.

The dispersion of colorant is prepared by mixing and dispersing a colorant, a dispersant in deionized water. According to the present invention, the colorant is a pigment.

The pigment that may be used as a colorant according to the present invention is selected from the group consisting of azo-based pigments, phthalocyanine-based pigments, basic dye-based pigments, quinacridone-based pigments, dioxazine-based pigments, condensed azo-based pigments, carbon black, chromates, ferrocyanides, oxides, sulfides, selenides, sulfates, silicates, carbonates, phosphates and metal powder.

The above-described pigments may be used alone or in combination. However, the pigment that may be used in the present invention is not limited to the above-described pigments.

Among those, it is preferable to use an organic pigment considering the environmental effects and a preferred black pigment is carbon black.

Particular examples of the organic pigment that may be used in the present invention include the following:

Blue and/or green pigments include copper phthalocyanine, C.I.P.B.15, 15:1, 15:2, 15:3, 15:4, 15:6, 16 (metal-free phthalocyanine) or phthalocyanine having a central metal element such as aluminum, nickel or vanadium, bridged phthalocyanine dimer/oligomer such as Si-bridged phthalocyanine, or the like.

Orange pigments include P.O. 5, 62, 36, 34, 13, 43, 71, 72

Yellow pigments include P.Y. 12, 113, 17, 74, 83, 93, 122, 146, 155, 180, 174, 185

Red pigments include P.R. 48, 57, 122, 146, 147, 176, 184, 186, 202, 207, 238, 254, 255, 270, 272

Violet pigments include P.V. 1, 19, 23

Mixed pigments include P.V. 19/P.R. 122 or 146/147

The dispersant used for preparing the dispersion of colorant may be a water soluble polymer, surfactant, inorganic compound, etc. However, a surfactant is often used as dispersant. Particular non-limiting examples of the dispersant that may be used in the present invention include: anionic surfactants including sodium dodecyl sulfate, sodium dodecylbenzene sulfonate, sodium dodecylnaphthalene sulfate, dialkyl benzenealkyl sulfate and sulfonate; cationic surfactants including dialkyl benzenealkyl ammonium chloride, alkyl benzyl methyl ammonium chloride, alkyl benzyl dimethyl ammonium bromide, benzalkonium chloride, cetyl pyridinium bromide, dodecylbenzyl triethyl ammonium chloride, laurylamine acetate, stearylamine acetate and lauryl trimethyl ammonium chloride; amphoteric surfactants including lauryl dimethylamine oxide; and non-ionic surfactants including polyvinyl alcohol, polyacrylic acid, metallose, methyl cellulose, ethyl cellulose, propyl cellulose, hydroxyethyl cellulose, carboxymethyl cellulose, tristyrylphenol ethoxylate phosphate ester, polyoxyethylene cetyl ether, polyoxyethylene lauryl ether, polyoxyethyleneoctyl ether, polyoxyethylene octylphenyl ether, polyoxyethylene oleyl ether, polyoxyethylene sorbitan monolaurate, polyoxyethylene stearyl ether, polyoxyethylene nonylphenyl ether and dialkylphenoxy poly(ethyleneoxy)ethanol. The above-described surfactants may be used alone or in combination. Particular examples of commercially available surfactants include Dowfax, Tergitol, Triton, etc., available from Dow Chemical, Co.

Deionized water is used as continuous phase for the dispersion of colorant.

Preferably, ultrapure water is used, which is deoxygenated by bubbling nitrogen gas.

The colorant and dispersant as described above are introduced into ultrapure water and milled by using a mill to form the dispersion of colorant.

Particular examples of the mill that may be used in the present invention include a ball mill, Dino mill, EIGER MILL 250 or Dispermat. To such mills, the colorant and dispersant mixed in ultrapure water are introduced and then milled with glass beads at a speed of 2000 rpm-10000 rpm for 1-5 hours, thereby providing the dispersion of colorant. The time and speed needed for carrying out milling depend on the composition and mixing ratio of the dispersion.

In a separate container, an organic phase comprising core monomers for preparing the latex and wax is heated and mixed to provide a blend of wax and monomers.

The monomer for forming the core of the latex, which is hereinafter referred to as the core monomer, may be a polymerizable monomer, which is at least one selected from the group consisting of a styrenic monomer, acrylate monomer, methacrylate monomer, acrylic acid, itaconic acid, methacrylic acid, maleic acid, fumaric acid, sulfonated styrene, vinyl monomer, acrylonitrile, butadiene and isoprene. However, the core monomer that may be used in the present invention is not limited thereto. Any polymerizable monomers known to one skilled in the art may be used in the present invention.

Non-limiting examples of the styrenic monomer include styrene, o-methylstyrene, m-methylstyrene, p-methylstyrene, α-methylstyrene, p-methoxystyrene, o-chlorostyrene, m-chlorostyrene, p-chlorostyrene, dichlorostyrene, p-tert-butylstyrene, p-n-butylstyrene, p-phenylstyrene, p-n-nonylstyrene, etc.

Non-limiting examples of the acrylate monomer include acrylate, methyl acrylate, ethyl acrylate, propyl acrylate, isobutyl acrylate, n-butyl acrylate, beta-carboxyethyl acrylate, hydroxyethyl acrylate, ethylhexyl acrylate, trimethylpropane triacrylate, etc.

Non-limiting examples of the methacrylate monomer include methyacylate, methyl methacrylate, ethyl methacrylate, propyl methacrylate, n-propyl methacrylate, isopropyl methacrylate, n-butyl methacrylate, isobutyl methacrylate, n-octyl methacrylate, dodecyl methacrylate, stearyl methacrylate, hydroxyethyl methacrylate, 2-ethylhexy methacrylate, etc.

Non-limiting examples of the vinyl monomer include vinyl pyridine, vinyl pyrrolidone, 1,2-divinyl benzene, 1,3-divinyl benzene, 1,4-divinyl benzene, 1,2-diisopropenyl benzene, 1,3-diisopropenyl benzene, 1,4-diisopropenyl benzene, 1,2,4-triethenyl benzene, 1,3,5-triethenyl benzene, 2,6-diethenyl naphthalene, 1,7-diethenyl naphthalene, 1,4-diethenyl naphthalene, 2-chloro-1,4-diethenyl benzene, etc.

The monomer may be selected considering the glass transition temperature (Tg) of the resultant latex core formed after the polymerization. Particularly, when at least two kinds of monomers are mixed, the resultant latex core has a Tg variable depending on the particular type of a monomer and amount thereof. It is possible to predetermine an adequate range of Tg according to the relevant technical field, in which the polymer latex of the present invention is applied, and thus to select a suitable monomer to provide a latex having the Tg.

Tg of a polymer may be calculated by using a known Tg value for the corresponding homopolymer and the Fox equation represented by the following formula 1. The Fox equation is described in [A. W. Wicks, edited by F. N. Johnes S. P. Pappa, Organic coatings, 1, John Wiley, New York, pp. 54-55 (1992)].

$$\frac{1}{Tg} = \frac{W 1}{Tg 1} + \frac{W 2}{Tg 2} \qquad [ Formula 1 ]$$

wherein Wi represents a weight fraction of monomer “i”, and Tgi represents Tg of the homopolymer of monomer “i”.

It is possible to determine kinds and amounts of monomers conformed to a desired value of Tg for the latex core by using the above Formula 1. More particularly, Tg of the core is set to a desired temperature value, monomer “1” and monomer “2” to be used in the polymerization are determined, and then weight fraction of each of monomer “1” and monomer “2” is determined according to Formula 1.

For example, homopolymers of typical polymerizable monomers have a Tg as shown in the following Table 1:

TABLE 1

| Monomer | Tg(° C.) |
|---|---|
| t-butyl methacrylate | 107 |
| n-butyl methacrylate | 20 |
| n-butyl acrylate | −55 |
| Ethyl acrylate | −24 |
| Methyl acrylate | 105 |
| Ethyl methacrylate | 66 |
| Lauryl methacrylate | −65 |

The wax that may be used in the present invention is referred to as a natural or synthetic material, which has kneadability and hardness or brittleness, is present in a crude particle state or microcrystalline state and is translucent or opaque at 20° C., while being melted without any decomposition at a temperature of higher than 40° C. The wax also has a relatively low viscosity and non-viscosity at a temperature slightly higher than its melting point, and shows a temperature-dependent constancy and solubility.

The wax that may be included in the latex core according to the present invention includes a wax that is commercially available or is synthesized in a laboratory. Particular examples of such wax includes: natural wax including natural vegetable wax such as carnauba wax and bayberry wax, and natural animal wax such as bees wax, Shellac wax and Spermacetti wax; mineral wax including Montan wax, Ozokerite wax and Ceresine wax; petroleum wax including paraffin wax and microcrystalline wax; and synthetic wax including Fischer-Tropsch wax, polyethylene wax, polypropylene wax, acrylate wax, fatty acid amide wax, silicone wax and polytetrafluoroethylene wax. The above-described wax may be used alone or in combination. However, the wax that may be used in the present invention is not limited the above-described examples.

To the mixed organic phase formed of the monomer and wax, a chain transfer agent is added and the resultant mixture is mixed with heating.

The chain transfer agent is added to control the molecular weight of the resultant polymer. Particular examples of the chain transfer agent that may be used in the present invention include 1-dodecanediol, n-octyl mercaptane, n-dodecyl mercaptane, t-dodecyl mercaptane, 2-mercaptoethanol, diisopropyl xanthogen, carbon tetrachloride, trichlorobromomethane, octanediol, stearyl thiol, n-octyl 3-mercaptopropionate, α-methylstyrene dimer and ethyleneglycol bis(3-mercaptopropionate), etc. The above-described chain transfer agents may be used alone or in combination. However, the chain transfer agent that may be used in the present invention is not limited the above-described examples.

Then, the dispersion of colorant obtained as described above is further mixed with the blend of wax and monomer, and a polymerization initiator for forming the core is added thereto to carry out polymerization, thereby forming the latex core.

In general, because a pigment serves as radical scavenger during synthesis of latex particles, it interrupts a polymerization reaction to decrease the reactivity in the polymerization reaction, resulting in a failure in formation of latex and an increase in the amount of residual monomers. To solve the above problem, the method according to the present invention uses a different polymerization initiator when forming the latex core, so that the polymerization reaction carried out in the presence of a mixture of a pigment with monomers cannot be adversely affected by the pigment.

The polymerization initiator that may be used in the present invention includes azo-based polymerization initiators. Such azo-based polymerization initiators may be used alone or in combination. However, it is preferable to use a combination of an azo-based polymerization initiator with a persulfate-based polymerization initiator or with a peroxide-based polymerization initiator.

Preferably, the azo-based polymerization initiator that may be used in the present invention is an aqueous polymerization initiator. Such aqueous polymerization initiators are known to maintain a polymerization reaction for a long time due to their long half-life and mild reactivity. By virtue of the characteristics of an azo-based initiator, it is possible to remove the so-called scavenger effect caused by a pigment and thus to improve polymerization efficiency.

The azo-based polymerization initiator that may be used in the present invention includes at least one selected from the group consisting of azoamidine compounds, azoamide compounds, azoalkyl compounds, azoester compounds and azonitrile compounds. However, the azo-based polymerization initiator that may be used in the present invention is not limited to the above-described examples.

Particular non-limiting examples of azoamidine compounds include 2,2′-azobis(2-methyl-N-phenylpropionamidine)dihydrochloride, 2,2′-azobis[N-(4-chlorophenyl)-2-methylpropionamidine]dihydrochloride, 2,2′-azobis[N-(4-hydroxyphenyl)-2-methylrpopionamidine]dihydrochloride, 2,2′-azobis[N-(hydroxyphenyl)-2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis(2-methylpropionamidine) dihydrochloride, 2,2′-azobis[N-(2-hydroxyethyl)-2-methylpropionamidine]dihydrochloride, 2,2′-azobis[2-(5-methyl-2-imidazoline-2-yl)-propane]dihydrochloride, 2,2′-azobis[2-(2-imidazoline-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl-propane)dihydrochloride, 2,2′-azobis{2-[1-(2-hydroxyethyl)-2-imidazolin-2-yl]propane}dihydrochloride, 2,2′-azobis[2-(2-imidazolin-2-yl)propane], etc.

Particular non-limiting examples of azoamide compounds include 2,2′-azobis{2-methyl-N-[1,1-bis(hydroxymethyl)-2-hydroxyethyl]propionamide}, 2,2′-azobis{2-methyl-N[1,1-bis(hydroxymethyl)ethyl]propionamide}, 2,2′-azobis[2-methyl-N(2-hydroxyethyl)propionamide, 2,2′-azobis(2-methylpropionamide)dihydrate, etc.

Particular non-limiting examples of azoalkyl compounds include 2,2′-azobis(2,4,4-trimethylpentane), 2,2′-azobis(2-methylpropane), etc.

Particular non-limiting examples of azoester compounds include dimethyl-2,2′-azobis(2-methylpropionate), etc.

Particular non-limiting examples of azonitrile compounds include 2,2′-azobisisobutyronitrile, 2,2′-azobis(2-methylbutyronitrile), 2,2′-azobis(4-methoxy-2,4-dimethylvaleronitrile), 2,2′-azobis-(2,4-dimethylvaleronitrile), 1,1′-azobis(cyclohexane-1-carbonitrile), 2-(carbamoylazo)isobutyronitrile, 2-phenylazo-4-methoxy-2,4-dimethylvaleronitrile, etc.

Examples of persulfate-based polymerization initiators include potassium persulfate, ammonium peroxysulfate, sodium peroxysulfate, etc., but are not limited thereto.

Examples of peroxide-based polymerization initiators include o-chlorobenzoyl peroxide, o-methoxybenzoyl peroxide, lauroyl peroxide, ocatanoyl peroxide, methyl ethyl ketone peroxide, diisopropyl peroxydicarbonate, cumene hydroperoxide, cyclohexanone peroxide, t-butyl hydroperoxide, diisopropylbenzene hydroperoxide, hydrogen peroxide, para-menthane peroxide, peroxycarbonate, etc., but are not limited thereto.

Preferably, each of the mixing ratio of an azo-based polymerization initiator to persulfate-based polymerization initiator and that of an azo-based polymerization initiator to peroxide-based polymerization initiator is 1:1. However, such mixing ratios are variable depending on particular types and amounts of monomers participating in the polymerization reaction and pigments interrupting the polymerization reaction.

After the polymerization initiator for forming the core is added to the mixture containing the dispersion of colorant and the blend of wax with monomers, polymerization reaction is performed at about 50° C. to 80° C. for about 2-10 hours. By doing so, it is possible to obtain core polymer particles having an average particle size of about 100 nm to 500 nm.

Then, to the container including the core polymer particles obtained as described above, shell monomers are added and then a polymerization initiator for forming the shell is further added thereto, thereby forming a shell layer of polymer latex.

The shell monomers include at least one selected from the group consisting of a styrenic monomer, acrylate monomer, methacrylate monomer, acrylic acid, itaconic acid, methacrylic acid, maleic acid, fumaric acid, vinyl monomer, acrylonitrile, butadiene and isoprene. However, the core monomers that may be used in the present invention are not limited to the above-described monomers.

Particular examples for the styrenic monomer, acrylate monomer, methacrylate monomer and vinyl monomer are the same as those for the core monomers.

Additionally, the shell monomers may be the same as the core monomers.

When selecting the shell monomers, particular kinds and amounts of the monomers may be determined considering Tg of the resultant latex shell in a similar manner to the selection of the core monomers.

The polymerization initiator for forming the shell that may be used in the present invention includes the peroxide-based polymerization initiators and persulfate-based polymerization initiators as described. Other polymerization initiators currently used in the art may also be used.

Preferably, the polymerization reaction for forming the shell layer of latex is carried out at a temperature of about 50-80° C. for about 5-20 hours. The temperature and time needed for carrying out polymerization depend on particular types and amounts of shell monomers.

After forming the shell layer, the reaction mixture is cooled naturally at room temperature to provide a finished latex resin.

The core/shell polymer latex particles obtained as described above are preferably formed from a latex polymer having a Tg of about 40-100° C. Under the consideration for dispersibility and storability of the latex resin in a toner composition for image forming devices, to which the polymer latex particles of the present invention are applied, as well as for fixing temperature during an image forming process, the latex resin preferably has a Tg of between about 40° C. and 100° C.

Further, the core/shell latex particles obtained as described above preferably has an average particle size of between about 0.1 μm and 3 μm. Considering the particle size of a finished toner composition to which the polymer latex of the present invention is applied, the latex particle size preferably ranges from about 0.1 μm and 3 μm.

According to the core/shell polymer latex obtained as described, it is possible to prepare a latex comprising wax and a colorant encapsulated therein through a single process and thus to reduce the number of processing steps. Additionally, it is possible to improve a bonding degree between the latex and wax/colorant, and distribution uniformity and encapsulation ratio of the components, and thus to facilitate control of the content of each component in a polymer composition using the latex resin. Particularly, in the case of a conventional latex having a core comprising a colorant (for example, a pigment), it is difficult to include the colorant in the latex core because the pigment generally inhibits the polymerization of the latex core. However, according to the present invention, it is possible to include a colorant in the latex core with ease.

### EMBODIMENTS FOR CARRYING OUT THE INVENTION

Reference will now be made in detail to the preferred embodiments of the present invention.

### Example 1

Preparation of Latex Core

30 g of P.B.15:3, 100 g of ultrapure water and 10 g of Dowfax were milled along with 200 g of glass beads by using Dispermat at 3000 rpm for 1 hour to provide a dispersion of colorant.

In a separate container, 8 g of 1-dodecanediol and 10 g of ester wax are added to 100 g of a monomer mixture containing styrene, butyl acrylate and acrylic acid in a ratio of 7:2:1, and then the resultant mixture was heated and mixed to provide a blend of wax and monomers.

Next, an aqueous solution containing 30 g of the dispersion of colorant and 350 g of ultrapure water was introduced into a reaction container and the container was heated to 80° C. In a separate container, an aqueous dispersion of dispersant was formed by dissolving 1 g of Dowfax and 1 g of Triton into 350 g of ultrapure water.

To a 1-L reactor, the monomer mixture, aqueous dispersion of colorant and the aqueous solution of dispersant were introduced and mixed. Next, the resultant mixture was homogenized in a homogenizer at about 7000 rpm for about 10 minutes.

The homogenized materials were introduced into a water bath and heated to about 80° C. while agitating at a speed of about 100 rpm. When the temperature of the water bath reached 80° C., a mixed polymerization initiator containing 2,2′-azobis{2-methyl-N[1,1-bis(hydroxymethyl)ethyl]propionamide}and methyl ethyl ketone peroxide in a ratio of 1:1 was added thereto in a small amount and the reactor was purged with nitrogen gas. The polymerization reaction was carried out for about 2 hours. Finally, a latex core comprising wax and colorant, and having a particle size of about 250 nm was obtained.

Preparation of Latex Shell Layer

To a monomer mixture containing 55 g of styrene, 20 g of butyl acrylate and 7 g of methyl acrylate, 1.5 g of 1-dodecanediol was added to provide a mixture of shell monomers. The monomer mixture was mixed with the latex core obtained as described above and a small amount of potassium peroxysulfate was added to the resultant mixture to carry out polymerization at about 80° C. for about 3 hours.

After the completion of the polymerization, the reaction mixture was cooled naturally at room temperature to form a shell layer on the surface of latex core, thereby providing core/shell polymer latex particles.

The core/shell polymer latex particles had a Tg of 70° C., melting point of 112° C., volume average size of 270 nm and a number average size of about 230 nm.

### Example 2

Example 1 was repeated to provide core/shell polymer latex particles, except that 80 g of polyethylene wax emulsion was used instead of the ester wax.

The core/shell polymer latex particles had a Tg of 69° C., melting point of 110° C., volume average size of 162 nm and a number average size of about 122 nm.

### Example 3

Example 1 was repeated to provide core/shell polymer latex particles, except that acrylic acid in the core monomers was substituted with methacrylic acid.

The core/shell polymer latex particles had a Tg of 69° C., melting point of 85° C., volume average size of 300 nm and a number average size of about 140 nm.

### Example 4

Example 1 was repeated to provide core/shell polymer latex particles, except that 120 g of paraffin wax emulsion was used instead of the ester wax.

The core/shell polymer latex particles had a Tg of 69° C., melting point of 60° C., volume average size of 190 nm and a number average size of about 144 nm.

### Example 5

Example 1 was repeated to provide core/shell polymer latex particles, except that the colorant P.B.15:3 was substituted with P.Y.180.

The core/shell polymer latex particles had a Tg of 68° C., melting point of 110° C., volume average size of 270 nm and a number average size of about 230 nm.

### Example 6

Example 1 was repeated to provide core/shell polymer latex particles, except that the colorant P.B.15:3 was substituted with P.R.122.

The core/shell polymer latex particles had a Tg of 68° C., melting point of 110° C., volume average size of 591 nm and a number average size of about 310 nm.

### Example 7

Example 1 was repeated to provide core/shell polymer latex particles, except that the colorant P.B. 15:3 was substituted with carbon black (Nipex 70).

The core/shell polymer latex particles had a Tg of 70° C., melting point of 109° C., volume average size of 150 nm and a number average size of about 101 nm.

As described above, according to the present invention, it is possible to prepare core/shell polymer latex particles, whose core comprises wax and a colorant, by using a simple emulsion polymerization process only, with no need of additional cohesion or melting processes, and thus to simplify the overall process. Additionally, it is possible to improve a bonding degree between heterogeneous particles and distribution uniformity, and thus to control the content of each component with ease. Further, when the core/shell polymer latex is used as latex resin in a polymer composition, it is possible to improve distribution of the constitutional elements of the composition and a bonding degree between the constitutional elements of the composition.

The foregoing embodiment and advantages are merely exemplary and are not to be construed as limiting the present invention. The present teaching can be readily applied to other types of methods. Also, the description of the embodiments of the present invention is intended to be illustrative, and not to limit the scope of the claims, and many alternatives, modifications, and variations will be apparent to those skilled in the art.

What is claimed is:

1. A method for preparing polymer latex particles having a core/shell structure, the method comprising the steps of:
forming a dispersion of a colorant;
heating and mixing an organic phase comprising monomers for forming a core and a wax to form a blend of the wax and monomers;
mixing the dispersion of the colorant with the blend of the wax and the monomers, and adding a first polymerization initiator to the resultant mixture to polymerize the monomers, thereby forming core polymer particles comprising the wax and colorant; and
mixing shell-forming monomers with the core polymer particles comprising the wax and colorant, and adding a second polymerization initiator to the resultant mixture to polymerize the shell-forming monomers, thereby forming a shell layer on the core polymer particles,
wherein the colorant is a pigment, and the first polymerization initiator for forming the core includes an azo-based polymerization initiator.

2. The method for preparing polymer latex particles having a core/shell structure according to claim 1, wherein the azo-based polymerization initiator is selected from the group consisting of an azoamidine compound, azoamide compound, azoalkyl compound, azoester compound and an azonitrile compound.

3. The method for preparing polymer latex particles having a core/shell structure according to claim 1, wherein the first polymerization initiator for forming the core is selected from the group consisting of a mixed initiator of an azo-based polymerization initiator with a persulfate-based polymerization initiator and a mixed initiator of an azo-based polymerization initiator with a peroxide-based polymerization initiator.

4. The method for preparing polymer latex particles having a core/shell structure according to claim 3, wherein the mixing ratio of the azo-based polymerization initiator with the persulfate-based polymerization initiator is 1:1.

5. The method for preparing polymer latex particles having a core/shell structure according to claim 3, wherein the mixing ratio of the azo-based polymerization initiator with the peroxide-based polymerization initiator is 1:1.

6. The method for preparing polymer latex particles having a core/shell structure according to claim 1, wherein the polymerization is performed at a temperature of about 50° C. to 80° C. for about 2-10 hours, in the step of forming the core polymer particles.

7. The method for preparing polymer latex particles having a core/shell structure according to claim 1, wherein the core polymer particles have a particle size of between about 100 nm and 500 nm.

8. The method for preparing polymer latex particles having a core/shell structure according to claim 1, wherein polymerization is performed at a temperature of about 50° C. to 80° C. for about 5-20 hours, in the step for forming the shell layer is performed.

9. The method for preparing polymer latex particles having a core/shell structure according to claim 1, wherein the core monomer includes a monomer selected from the group consisting of a styrenic monomer, acrylate monomer, methacrylate monomer, acrylic acid, itaconic acid, methacrylic acid, maleic acid, fumaric acid, vinyl monomer, acrylonitrile, butadiene and isoprene.

10. The method for preparing polymer latex particles having a core/shell structure according to claim 1, wherein the shell monomer includes a monomer selected from the group consisting of a styrenic monomer, acrylate monomer, methacrylate monomer, acrylic acid, itaconic acid, methacrylic acid, maleic acid, fumaric acid, vinyl monomer, acrylonitrile, butadiene and isoprene.

11. The method for preparing polymer latex particles having a core/shell structure according to claim 1, wherein the dispersion of colorant is prepared by mixing and dispersing a colorant, dispersant and deionized water.

12. The method for preparing polymer latex particles having a core/shell structure according to claim 1, wherein the colorant includes at least one selected from the group consisting of azo-based pigments, phthalocyanine-based pigments, basic dye-based pigments, quinacridone-based pigments, dioxazine-based pigments, condensed azo-based pigments, carbon black, chromates, ferrocyanides, oxides, sulfides, selenides, sulfates, silicates, carbonates, phosphates and metal powder.

13. The method for preparing polymer latex particles having a core/shell structure according to claim 1, wherein the wax includes at lease one selected from the group consisting of carnauba wax, bayberry wax, bees wax, Shellac wax, Spermacetti wax, Montan wax, Ozokerite wax, Ceresine wax, paraffin wax, microcrystalline wax, Fischer-Tropsch wax, polyethylene wax, polypropylene wax, acrylate wax, fatty acid amide wax, silicone wax and polytetrafluoroethylene wax.

14. The method for preparing polymer latex particles having a core/shell structure according to claim 1, wherein the core/shell polymer latex particles have a glass transition temperature (Tg) of between 40° C. and 100° C. and a melting point of between 50° C. and 150° C.

15. The method for preparing polymer latex particles having a core/shell structure according to claim 1, wherein the core/shell polymer latex particles have a particle size of between 0.1 μm and 3 μm.
